(19) United States
(12) Patent Application Publication
(10) Pub. No.: US 2012/0039979 A1
(43) Pub. Date: Feb. 16, 2012

(54) INSECT CONTROL SUBSTANCE THAT CAN BE APPLIED TO A SURFACE

(75) Inventors: Stephen Sexton, Queensland (AU); Ken Ingbritsen, Queensland (AU)

(73) Assignee: BIOGLOBAL LIMITED, Queensland (AU)

(21) Appl. No.: 13/025,831

(22) Filed: Feb. 11, 2011

Related U.S. Application Data
(63) Continuation-in-part of application No. 10/569,926, filed on Nov. 6, 2006, now abandoned.

(30) Foreign Application Priority Data
Aug. 29, 2003 (AU) 2003904657

(51) Int. Cl. A01N 25/26; A01P 19/00

(52) U.S. Cl. 424/419; 424/84

(57) ABSTRACT

An insect control substance for controlling certain flying insect pests in proximity to the substance includes a rubber crumb carrier having a plurality of rubber particles and a volatile hydrophobic semiochemical for attracting certain flying insect pests absorbed within the rubber particles forming a discontinuous phase of the substance. The insect control substance also includes a body of water forming a continuous phase of the substance within which the discontinuous phase is suspended. When the insect control substance is applied to an application surface the discontinuous phase is exposed to the surrounding air and the semiochemical within the rubber particles evaporates into the air around the application surface and attracts the flying insect pests to the rubber crumb carrier to facilitate control of the flying insect pests.

### CROSS-REFERENCE TO RELATED APPLICATION

This application is a continuation-in-part of U.S. patent application Ser. No. 10/569,926, filed Nov. 6, 2006, which claims the benefit of PCT Patent Application Serial No. PCT/AU2004/001172 filed on Aug. 30, 2004, and Australian Patent Application Serial No. 2003904657, filed Aug. 29, 2003.

### FIELD OF THE INVENTION

This invention relates to an insect control substance that can be applied to a surface for controlling certain flying insects in proximity thereto. This invention also relates to a method of controlling certain flying insects in proximity to a field of agricultural crops. This invention extends to a method of making an insect control substance that can be applied to a surface for controlling certain flying insects.

This invention relates particularly but not exclusively to an insect control substance that can be applied to a ground surface or a surface of a crop for controlling lepidopteran flying insects, in particular the Codling Moth (Codling) and the Oriental Fruit Moth (OFM). It will therefore be convenient to hereinafter describe the invention with reference to this example application. However at the same time it must be recognized that the invention is capable of broader application. For example the invention could be applied for the control of other flying insects including flies, beetles and wasps.

### DEFINITIONS

In this specification the terms “comprise”, “comprises” and “comprising” are used inclusively rather than exclusively, and will be understood to imply the inclusion of a stated integer or group of integers but not the exclusion of any other integer or group of integers.

In this specification the term “semiochemical” is meant a biologically active volatile compound that affects the behavior of insects and includes pheromones, kairomones and allomones. The term “semiochemical” shall be understood to include compounds that are manufactured synthetically that mimic or imitate the behavior of chemicals actually produced by insects. Further the term semiochemical where used in the specification shall be understood to include a mixture of a number of chemicals.

In this specification the term “rubber crumb” is to be interpreted broadly and is not to be construed that the particles of rubber are of any particular size, such as the size of bread crumbs. On the contrary a wide range of sizes of crumbs are contemplated to fall within the scope of this term. Further the term defines a rubber material that is derived from a natural rubber and also a rubber material that is obtained from synthetic rubber.

In this specification the term “thick liquid” shall be interpreted broadly and shall include a flowable liquid having a viscosity resembling thick syrup or treacle. Yet further the term the term thick liquid shall include a liquid having solid particles contained therein and it shall not be limited to a liquid that is free of solid particles.

In this specification the term “insecticide” shall be interpreted broadly and shall include all forms of material that is intended to kill a target flying insect when it is consumed or inhaled by the target flying insect.

In this specification the term “anti-oxidant” shall be interpreted broadly and may be any substance that improve the shelf life of the formulation and prevent unwanted degradation and/or oxygenation of the semiochemical in the formulation.

In this specification the term “separating the water from the rubber crumb carrier” shall be understood to mean removing the water from its surrounding relationship with the rubber carrier by whatever manner this occurs. For example it shall include causing water to run off the rubber crumb carrier when it is dispensed from a container and it shall include evaporation of the water off the rubber crumb carrier drying the rubber crumb carrier. However it shall not be limited to these two forms of separating the water from the carrier.

In this specification where components of the insect control substance are described such as semiochemical, anti-oxidant, volatility suppressing agent, thickener, colouring agent, humectant, wetting agent or surfactant, the term is not to be limited to one such component or chemical. It shall also be understood to cover one or more components or chemicals making up the semiochemical, anti-oxidant, volatility suppressing agent, thickener, colouring agent, humectant, wetting agent or surfactant.

In this specification the term “particle size” shall be understood to define the maximum dimension of the particle in one dimension. Accordingly the relevant particle will be able to pass through a mesh opening corresponding to the desired particle size.

In this specification the term “attract and kill substance” may define a substance including a feeding stimulant for encouraging the target flying insect to feed on the substance and ingest it and an insecticide for killing the insect when it ingests the substance.

### BACKGROUND TO THE INVENTION

Agricultural crops are prone to damage or destruction by flying insect pests. Cumulatively flying insect pests cause billions of dollars of damage to agricultural crops each year. The damage caused to field crops in broadacre farming operations is particularly severe.

One known way of controlling flying insect pests and the damage they cause to crops is to spray an insecticide onto the crops or onto the area around the crops. However the use of insecticide deposits poisonous chemicals onto soil and into surface waters in the environment. Further an application of insecticide to an actual crop plant including the fruit thereof can be harmful to a person consuming the fruit. The dangers of widespread use of insecticides and their consequent release into the environment have been well documented in the literature.

There is therefore a need to devise other ways of controlling flying insect pests in relation to agricultural crops, that are not as environmentally harmful as spraying with insecticide, yet which are efficacious at limiting crop damage caused by flying insects. This is a particular challenge in broad acre farming operations where soil crops such as cotton, soybeans, tomatoes, cucumbers, and corn are grown.

### SUMMARY OF THE INVENTION

The Applicant has found that a carrier of rubber particles readily absorbs semiochemicals. Rubber is compatible with the hydrophobic semiochemicals and readily absorbs the semiochemical into internal passages within the rubber particles. Further the semiochemical is slowly released once the water surrounding the rubber particles is removed, thereby exposing the rubber particles to surrounding air. The semiochemical is released in a sustained fashion over an extended period of time and attracts insects thereto over this sustained period.

Further a rubber crumb carrier that is dispersed in an aqueous phase can provide prolonged field life or operational longevity in terms of release of semiochemicals. A range of insecticides and feeding stimulants that are used for pest control are dissolved in an aqueous medium. Applicant has recognized that these aqueous insecticides and feeding stimulants can be mixed in the aqueous medium. The aqueous phase which is subsequently mixed with the rubber crumb carrier containing the semiochemical forms a continuous phase which receives the rubber crumb carrier which forms the discontinuous phase. When the water evaporates and the rubber crumb carrier dries, the insecticides and feeding stimulants which are non-volatile solutes within the aqueous medium, remain on the surface of the rubber crumb carrier. That is they are deposited on the surface where they present to insects and can be consumed by insects that are attracted thereto. The interaction between the aqueous medium carrying both the insecticide and the stimulant and the rubber crumb carrier with its absorbed semiochemical is particularly effective.

Further the covalent rubber particles have an ability to adhere to a solid surface with which they come into contact and repel polar water molecules. Once the rubber crumb carrier has dried on the solid surface is not easily detached from its adherence to the surface by rain water.

The Applicant has devised a substance that can absorb a hydrophobic semiochemical and slowly release it over an extended period of time. The substance also has an aqueous medium that contains insecticide and feeding stimulant. When the water is removed from the rubber crumb carrier, the insecticide and feeding stimulant locate on the carrier surface where they present to flying insects. Further the rubber carrier resists wash off by rain.

According to one aspect of the invention there is provided an insect control substance for controlling certain flying insect pests in proximity thereto, including:
a rubber crumb carrier comprising a plurality of rubber particles and a volatile hydrophobic semiochemical for attracting certain flying insect pests absorbed within the rubber particles, the carrier forming a discontinuous phase; and
a body of water forming a continuous aqueous phase within which the discontinuous phase is suspended,
wherein the discontinuous phase formed by the rubber crumb carrier is separated from the aqueous phase and exposed to air when the substance is applied to an application surface, and the semiochemical evaporates into the air to attract the flying insect pests to the rubber crumb carrier whereby to facilitate control of the flying insect pests.

The body of water forming the continuous aqueous phase of the substance may include a thickener for increasing the viscosity of the substance.

The rubber crumb carrier may include a volatility suppressing agent mixed together with the semiochemical that is absorbed within the rubber particles for retarding the rate at which the semiochemical evaporates from the rubber crumb carrier into the surrounding air. This thereby extends the length of time over which effective amounts of semiochemical evaporate off the rubber crumb carrier.

The volatility suppressing agent may be alpha tocopherol or Vitamin E acetate.

The rubber crumb carrier may also include an anti-oxidant mixed together with the semiochemical that is absorbed within the rubber particles. The anti-oxidant may be Vitamin E acetate.

According to another aspect of the invention there is provided an insect control substance for controlling certain flying insect pests in proximity thereto, including:
a rubber crumb carrier comprising a plurality of rubber particles and a volatile hydrophobic semiochemical absorbed within the rubber particles that is closed off from air within the atmosphere,
wherein on application of the substance to an application surface, the rubber crumb carrier is exposed to air and the semiochemical within the rubber particles evaporates therefrom into air surrounding the carrier, whereby to attract the flying insect pests to the substance and thereby facilitate control thereof.

The semiochemical may be substantially evenly distributed throughout each rubber particle. Further each rubber particle may be substantially saturated with semiochemical.

The insect control substance may include a body of water within which the rubber crumb carrier is contained which resists evaporation of the semiochemical from the rubber particles until it is separated therefrom.

In use the rubber crumb carrier is separated, e.g. liberated, from the body of water when the insect control substance is applied to the application surface thereby permitting the semiochemical to evaporate from the rubber particles into the surrounding air. The application of the substance to the application surface may cause some water to separate from the rubber crumb carrier by flowing off the rubber crumb carrier, and other water may evaporate off the rubber crumb carrier into the surrounding air, exposing the surface of the rubber particles to the surrounding air.

The insect control substance may include a thickener mixed into the body of water for increasing the viscosity of the body of water and the rubber crumb carrier received therein. The mixture of rubber crumb carrier dispersed within the body of water may have a high viscosity resembling a thick liquid such as thick porridge or syrup. The thickener may assist in binding the rubber particles of the rubber crumb carrier to each other when the carrier dries and also prevents separation of the rubber crumb carrier within the aqueous phase when the substance is in storage prior to use.

Further the substance may be capable of being dispensed from a container onto the support surface. In one form the substance may be in the form of a paste that can be formed and spread on the surface. In another form the substance may be flowable, e.g. in the form of a thick liquid.

After the substance has been applied to the application surface and the water has been separated therefrom, the rubber crumb carrier may form a carrier body, e.g. in the form of a body that has a thickness on the application surface, e.g. a thickness of 2 to 10 mm on the application surface.

The thickener may be a polymer that is a naturally derived polymer or a synthesized polymer. The polymer may be linear, branched or cross-linked.

Optionally the thickener may be a vegetable gum including cellulose. For example the thickener may be a polysaccharide including polyethylene glycols, polyethylene oxides, polyvinylpyrrolidones or polyacrylic acid. The thickener may also be a protein gum such as gelatin and gluten. The thickener may also be an organic hydrophilic gum such as xanthan gum, carboxymethyl cellulose gum, alginate gum, carrageenan gum, locust bean gum, tragacanth gum or guar gum.

The insect control substance may further include a volatility suppressing agent mixed together with the semiochemical for retarding the rate at which the semiochemical evaporates from the rubber particles of the rubber crumb carrier into the surrounding air and thereby influencing the length of time over which an effective quantity of semiochemical is released into the surrounding air.

The volatility suppressant may include alpha tocopherol, alpha tocopherol acetate, vitamin E acetate, oils or waxes of animal, vegetable or mineral origin, shellac, rosin and synthetics such as silicones and acrylates. The volatility suppressant may be mixed together with the semiochemical prior to its absorption into the rubber particles.

Further the insect control substance may include an anti-oxidant for resisting degradation of the semiochemical, e.g. by oxidation, and thereby increasing the life of the semiochemical. The anti-oxidant may include any one or more of vitamin E, vitamin E acetate, butylated hydroxytoluene (BHT) and butylated hydroxyanisole (BHA), and may be absorbed within rubber particles with the semiochemical.

Optionally substantially all the rubber particles may be sized to pass through a mesh opening of not more than 2.00 mm. Conveniently the rubber particles may be in the form of a fine powder having a large surface area. The rubber crumb carrier may comprise 1 part by weight of semiochemical for each 1 to 2 parts by weight of rubber particles free of semiochemical. Further the rubber crumb carrier may include 0.01 to 5-0% by weight of semiochemical, e.g. 0.5 to 50% by weight thereof. The rubber crumb carrier and the semiochemical received within the rubber crumb carrier when considered together may comprise 0.02 to 50% of the overall weight of the insect control substance including the body of water.

The rubber particles may include carbon black. The carbon black may make up 1 to 35% by weight of the total weight of the rubber particles and may confer some protection against ultraviolet radiation from the sun. The rubber particles of the rubber crumb carrier may comprise vulcanised rubber and the vulcanized rubber may be obtained by chopping up recycled vehicle tyres which have carbon black.

The semiochemical may be an imitation pheromone, an imitation kairomone or an imitation allomone.

The insect control substance may further include an insect harming agent for harming insects that are attracted to the rubber crumb carrier. The insect harming agent may be an insecticide that kills at least some of the flying insects that are attracted to the substance and is suitable for being received within an aqueous medium.

The insect control substance may further include a feeding stimulant mixed with the rubber crumb carrier for stimulating a flying insect to consume the rubber crumb carrier and thereby the insecticide. In particular the insect feeding stimulant may include a sugar based compound that is suitable for being received within an aqueous medium.

The insect harming agent and the feeding stimulant may be received within the body of water, and when the water evaporates after application of the substance to the surface, the non-volatile insect harming agent and the feeding stimulant remain on a surface of the rubber crumb carrier.

It should be recognized that the insect control substance may be supplied to end users such as farmers without the insect harming agent and the feeding stimulant contained therein. These components may be mixed into the substance and specifically the body of water by the end user, when the control substance is mixed up by the end user just prior to being used.

The insect control substance may further include a colouring agent that is dissolved within the water to selectively attract certain insects thereto and discourage other flying insects and birds therefrom.

The colouring agent may be a coloured pigment that tends to attract the certain flying insect pest that the substance is controlling. The colouring agent may be selected such that it does not strongly attract other non target flying insects.

The insect control substance may include a humectant for improving the consistency of the substance and resisting the sugar feeding stimulant from drying out and flaking off the surface to which the substance is applied. The humectant may include glycerol, sorbitol glucose, fructose and invert sugar. In applications where phytotoxicity is a concern, glycerol should be avoided and glucose, fructose and invert sugar are preferred.

The insect control substance may further include a wetting agent or a surfactant for stabilizing in dispersing the rubber crumb carrier within the body of water. The wetting agent or surfactant may be amphoteric, cationic, ionic, or nonionic.

According to another aspect of this invention there is provided a formulation for the control of arthropod pests comprising one or more hydrophobic or non polar semiochemicals, water or an aqueous medium, a thickener and a rubber crumb carrier for said one or more semiochemicals wherein said semiochemical(s) are substantially homogenously dispersed throughout the carrier.

The formulation may comprise an additive which is a feeding stimulant or bait or an additive which is an insecticide or toxicant.

The formulation may comprise an additive selected from the group consisting of an anti-oxidant, pigment, volatility suppressant, humectant and anti-microbial agent.

The rubber crumb carrier comprises 1-35% carbon black.

The diameter or size of the rubber crumb particles may fall within the range 0.01-2.00 mm.

The rubber crumb carrier may comprise 0.01-50% of semiochemical by weight of the formulation. Further the rubber crumb carrier may comprise 0.5-50% of semiochemical by weight of the formulation. The amount of semiochemical in the final formulation may be 0.001-20% by weight.

The water or aqueous medium may comprise a thickener that makes up 0.1-5% by weight of the formulation.

The amount of rubber crumb and semiochemical(s) in the water or aqueous medium may be 0.02-50% by weight of the formulation.

The invention also extends to the formulation defined above when used for the protection of crops, fruit, trees and plants.

The invention also extends to the formulation defined above when used for the control of arthropod pests including flying insect pests such as moths, mosquitoes, flies, beetles and wasps.

The invention also extends to the formulation defined above when used for the control of pests on livestock and pets.

The invention also extends to the formulation defined above when used for the control of pests, such as cockroaches, ants, fleas, bedbugs and silverfish.

According to yet another aspect of this invention there is provided a method of controlling certain flying insects on a field of agricultural crops whereby to reduce damage to the agricultural crops by the flying insects, including:
applying an insect control substance to an application surface on the field, the insect control substance including a rubber crumb carrier comprising a plurality of rubber particles containing a volatile hydrophobic semiochemical that attracts certain flying insects absorbed therein; and
exposing the rubber crumb carrier to air to allow the semiochemical to evaporate from the rubber particles into air surrounding the insect control substance for attracting certain flying insects to the substance to facilitate control thereof.

The rubber crumb carrier may be contained within a body of water, and exposing the rubber crumb carrier to the surrounding air may include separating the body of water from the rubber crumb carrier once it has been dispensed onto the application surface.

Applying the insect control substance may include dispensing the substance from a container while displacing the container along the application surface. The insect control substance may be dispensed as a thick liquid from the container as it is displaced over the application surface and may subsequently form an application body of rubber crumb carrier on the surface. The thick liquid may spread out to some extent when it is dispensed on the application surface. However the high viscosity of the thick liquid limits the extent to which it spreads out over the application surface once it has been dispensed.

Applying the insect control substance to an application surface may include applying the substance to a surface formed by the ground surface. In particular the substance may be applied to the ground surface such that it forms a straight line between two linear rows of crops in a field of crops.

Displacing the container over the treatment surface may include displacing the container in a substantially straight line along the application surface.

Applying the insect control substance to the application treatment surface may include applying the substance to the surface such that it forms a plurality of lines, e.g. located at spaced intervals along the length of the field. Where the substance is arranged in lines on the field, each line of the substance may extend parallel to a line of crops, and the lines of the substance may be spaced apart from each other in a direction transverse to the lines of crops.

Each line may extend part of the length of the line of crops. Each line may extend for 50 m along a line of crops and then the line may stop. The line may be repeated at spaced intervals along the line of crops. Alternatively, the insect carrier substance may be applied in spots on a field or in lines around the perimeter of a field, particularly a small field.

Adjacent lines in the transverse direction may be separated by at least 20 lines of crops, e.g. 40 to 60 lines of crops, such as about 50 lines of crops.

Instead applying the insect control substance to an application surface may include applying the substance to a surface formed by a crop, e.g. a leaf surface of the crop.

Applying an insect control substance to an application surface may include applying the substance to a field of cotton, soybeans, tomatoes, cucumbers, or corn within the field.

According to another aspect of this invention there is provided a method of making a insect control substance that can be applied to an application surface for controlling insects, the method including:
mixing a plurality of rubber particles with a liquid semiochemical to absorb the semiochemical within the rubber particles to form a rubber crumb carrier; and
closing the rubber crumb carrier off from air whereby to resist evaporation of absorbed semiochemical from the rubber particles prior to its use in the field.

The method may further include mixing a volatility suppressant together with the semiochemical so that the volatility suppressant is absorbed into the rubber particles together with the semiochemical.

The method may further include mixing an anti-oxidant together with the semiochemical so that the anti-oxidant is absorbed into the rubber particles together with the semiochemical.

The volatility suppressant and the anti-oxidant may be mixed together with the semiochemical prior to the semiochemical being mixed with the rubber particles.

Closing the rubber crumb carrier off from exposure to the atmosphere may include enclosing the rubber crumb carrier within a body of water so that the rubber particles are not exposed to air in the atmosphere.

The method may include mixing a thickener with the body of water prior to it being mixed with the rubber crumb carrier. The thickener may be in the form of a solid or liquid that is contained in the body of water.

The method may further include mixing one or more of a colouring agent, a humectant, and an anti-microbial agent with the body of water prior to it being mixed with the rubber crumb carrier.

The method may further include mixing an emulsifier and optionally also a wetting agent with the body of water and contained rubber crumb carrier. The emulsifier assists the dispersion of a discontinuous phase formed by the rubber crumb carrier comprising hydrophobic rubber particles within a continuous phase formed by the body of water and the components contained therein.

The method may include mixing an insect harming agent with the body of water prior to it being mixed with the rubber crumb carrier. The insect harming agent may be an insecticide.

The method may include mixing a feeding stimulant with the body of water prior to it being mixed with the rubber crumb carrier.

It will be appreciated that the substance may be distributed and sold to users without an insect harming agent and a feeding stimulant contained therein, and these components may be mixed into the aqueous medium by the end user, e.g. the farmer, depending on the application for which the substance is being used, e.g. the flying insect that is being targeted.

According to yet another aspect of this invention there is provided a method of preparing a formulation for controlling arthropod pests, said method including the steps of (i) admixing a carrier which includes rubber crumb with one or a plurality of hydrophobic or non-polar semiochemicals for a period of time sufficient for the rubber crumb to absorb the semiochemical(s), wherein the semiochemical(s) is substantially dispersed throughout the rubber crumb; and (ii) combining the rubber crumb mixture of step (i) with water or an aqueous medium as well as a thickener.

The thickener is incorporated with the water or aqueous medium in step (ii).

The method may include adding one or more additives selected from the group consisting of a toxicant or insecticide, feeding stimulant or bait, pigment, volatility suppressant, humectant, anti-microbial agent and anti-oxidant.

The toxicant or insecticide, feeding stimulant or bait, pigment, anti-microbial agent and humectant may be admixed with the aqueous medium before the rubber crumb mixture is added in step (ii).

The anti-oxidant and volatility suppressant may be admixed with a semiochemical before the semiochemical is admixed with the carrier in step (i).

### DETAILED DESCRIPTION OF THE INVENTION

An insect control substance and a method of controlling insects using the insect control substance in accordance with this invention may manifest itself in a variety of forms. It will be convenient to hereinafter describe several embodiments and examples of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description. In the drawings:

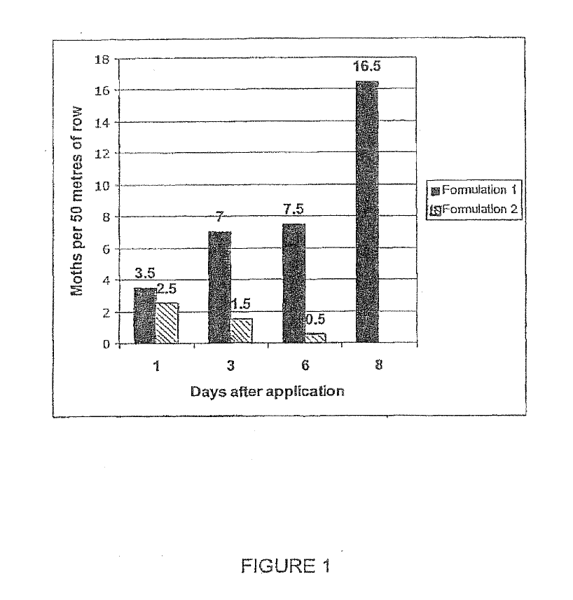

FIG. 1 is a line graph showing the number of moths killed in Example 4 described in the specific description;

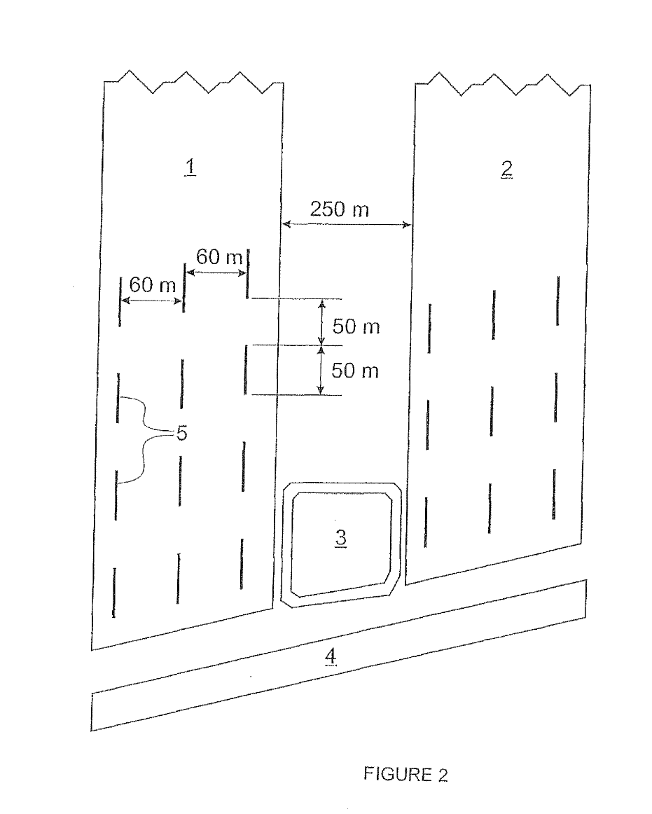

FIG. 2 is a schematic illustration of the layout of a field of crops used to carry out some experiments that are described in the specific description;

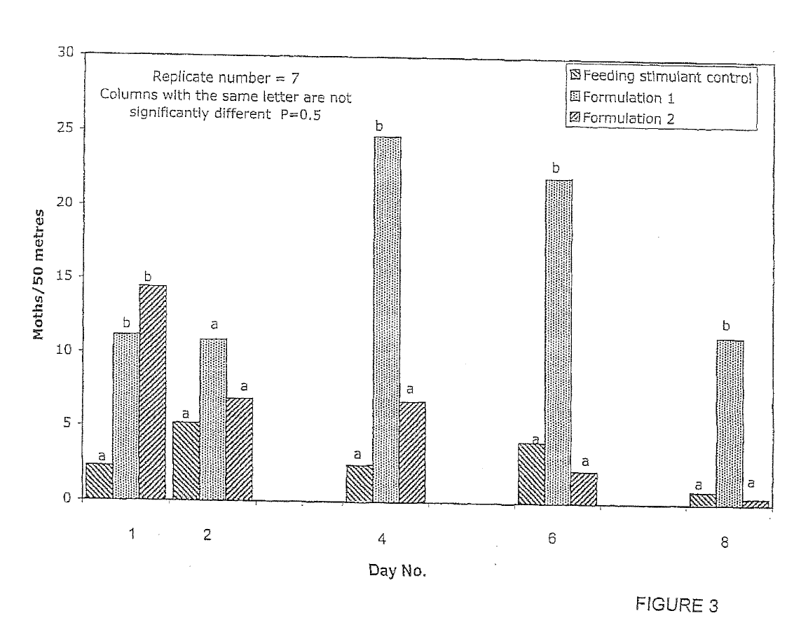

FIG. 3 is a line graph FIG. 1 is a line graph showing the number of moths killed in Example 5 described in the specific description;

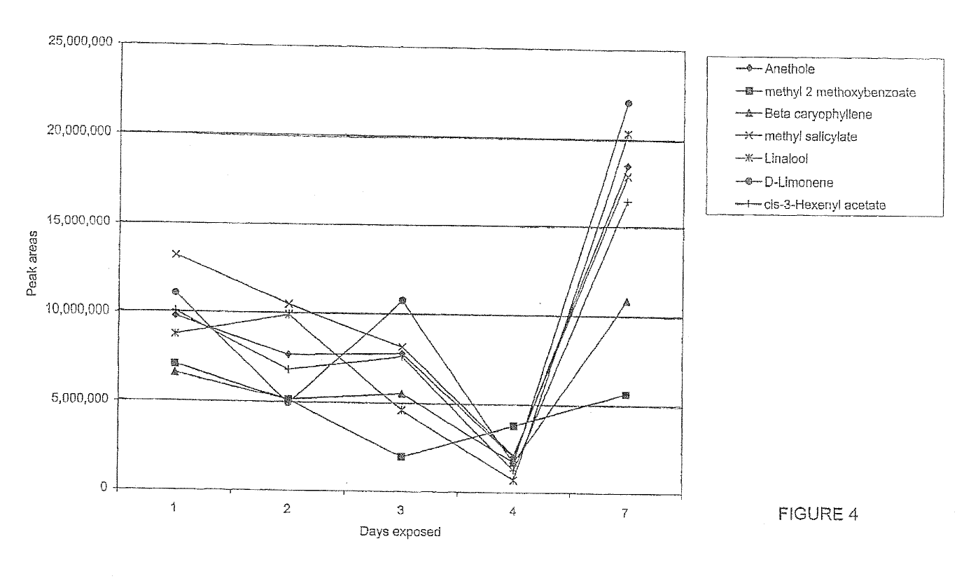

FIG. 4 is a graph showing the sustained release of semiochemical from the insect control substance corresponding to Formulation 1 in Example 6 described in the specific description;

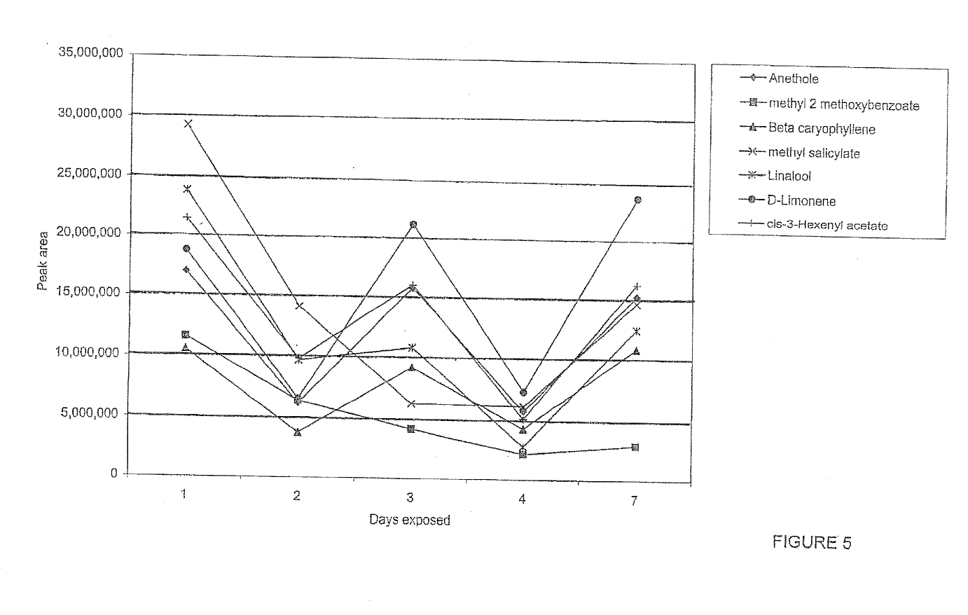

FIG. 5 is a graph showing the release of semiochemical from the insect control substance corresponding to Formulation 2 in Example 6 of the specific description;

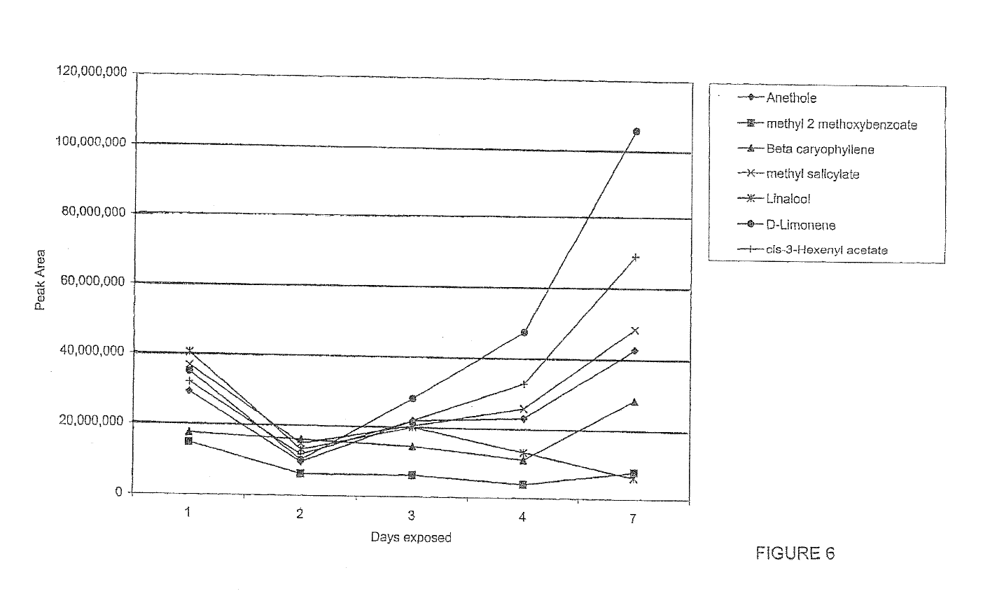

FIG. 6 is a graph showing the release of semiochemicals from the insect control substance corresponding to Formulation 3 in Example 6 of the specific description;

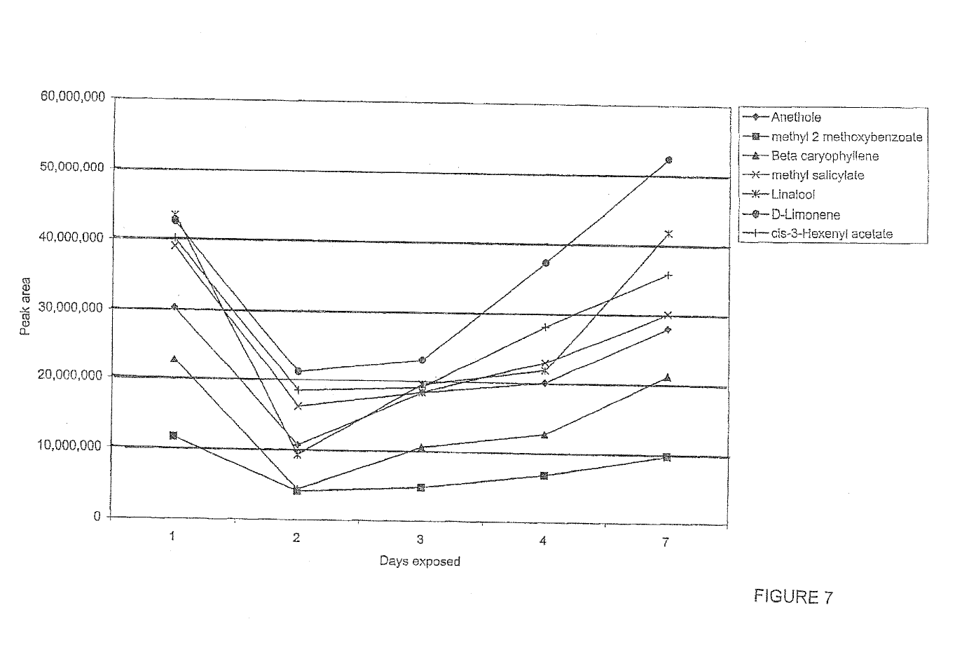

FIG. 7 is a graph showing the release of semiochemicals from the insect control substance corresponding Formulation 4 in Example 6 of the specific description; and

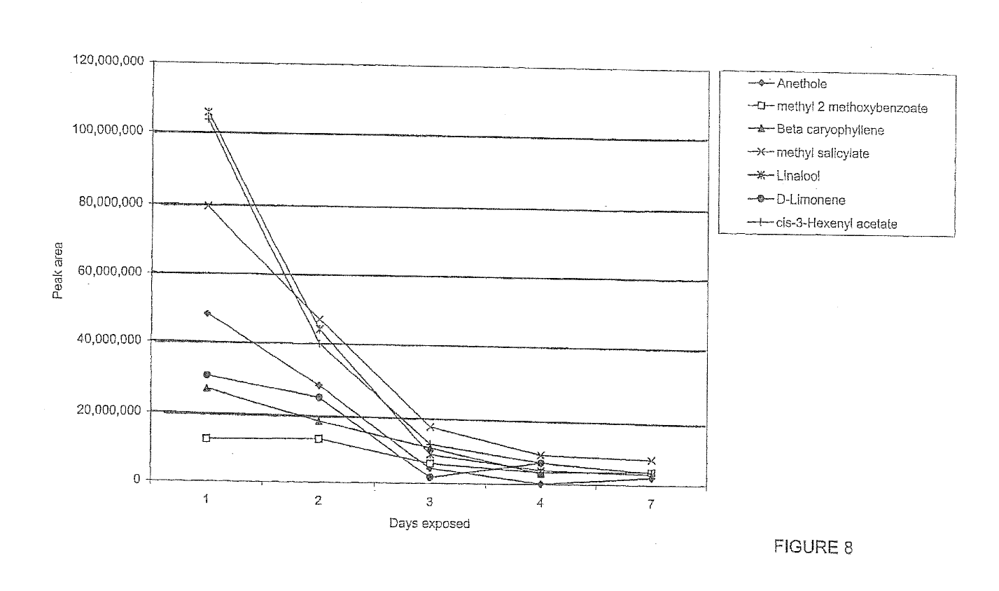

FIG. 8 is a graph showing the release of semiochemicals from the insect control substance corresponding to Formulation 5 in Example 6 of the specific description.

### COMPOSITION OF INSECT CONTROL SUBSTANCE

An insect control substance for controlling certain flying insect pests in accordance with one embodiment of the invention is in the form of an substance including a rubber crumb carrier comprising a plurality of rubber particles and a volatile hydrophobic semiochemical absorbed within the rubber particles. The rubber crumb carrier forms a discontinuous phase of the substance and provides a slow release carrier for the hydrophobic semiochemical retained within the rubber crumb carrier.

The substance also includes a body of water forming a continuous phase of the substance within which the discontinuous phase is dispersed. Each of the discontinuous and continuous phases of the substance will now be described in greater detail below.

In the discontinuous phase the particles of rubber are sized to pass through a mesh opening of not more than 2.00 mm. Conveniently the rubber particles are in the form of a fine powder which provides a large surface area for vaporization of the semiochemical into the surrounding air. The rubber particles of the rubber crumb carrier comprises vulcanised rubber that is obtained by chopping up recycled vehicle tyres. The rubber particles include carbon black in an amount of 1 to 35% by weight of the total weight of the rubber particles which confers some protection against ultraviolet radiation.

The rubber crumb may be sized to pass through 10-80 (British Standard Sieve) mesh but finer or coarser grades can be used. Preferably, the rubber crumb is sized to pass through 30 mesh and the diameter of the crumb particle size falls within the range 0.01-2.00 mm.

The semiochemical is substantially evenly distributed throughout each rubber particle, and each rubber particle is substantially saturated with semiochemical. In an example embodiment the rubber crumb carrier includes 1 part by weight of semiochemical for each 1-2 parts by weight of rubber particles. In general the ratio of semiochemical to rubber particles within the rubber crumb carrier should be sufficiently high to make sufficient semiochemical available to the rubber crumb carrier to saturate it.

The semiochemical is an imitation pheromone and it can also be an imitation kairomone or an imitation allomone. Some examples kairomones are disclosed in U.S. Pat. No. 6,074,634, which are effective for attracting Helicoverpa and related noctuid moth pests such as Spodoptera, the larvae of which are highly destructive of agriculture, lawns and turf.

The rubber crumb carrier includes a volatility suppressing agent mixed together with the semiochemical that is absorbed within the rubber particles for retarding the rate at which the semiochemical evaporates from the rubber crumb. This agent extends the length of time over which semiochemical is released into the surrounding air. Conveniently the volatility suppressing agent can be alpha tocopherol acetate or vitamin E acetate that is mixed together with the liquid semiochemical and absorbed into the rubber particles.

The rubber crumb carrier also includes an anti-oxidant including one or more of vitamin E, vitamin E acetate, butylated hydroxytoluene and butylated hydroxyanisole to resist degradation of the semiochemical, e.g. by oxidation, and improve the shelf life of the substance. The anti-oxidant is mixed together with the liquid semiochemical and the volatility suppressing agent prior to its absorption into the rubber particles.

The continuous phase includes a thickener for increasing the viscosity of the substance that is mixed into the body of water for increasing the viscosity of the body of water and the rubber crumb carrier received therein. The thickener also assists in binding the particles of the rubber crumb carrier to each other. The mixture of rubber crumb carrier dispersed within the body of water has a high viscosity resembling thick porridge or syrup.

The substance includes a colouring agent that is a pigment that is added to the body of water or the aqueous phase for making the formulation more attractive to target insects such as moths and less attractive to birds and other non-target flying insects. The pigment includes ferric oxide, titanium dioxide, zinc oxide or a Kraft food dye. In particular the coloured pigment may impart a green or red colour to the insect control substance for attracting moths thereto. A green or red colour also has an advantage that it does not attract honey bees strongly thereto. The colouring agent can be very beneficial when a sugar based feeding stimulant is used in the substance, as otherwise a honey bee would tend to be attracted to the sugar based feeding stimulant.

The substance also includes a humectant that is mixed together with the water prior to it being mixed with the rubber crumb carrier to improve the consistency of the substance. Suitable humectants may include glycerol, sorbitol glucose, fructose and invert sugar. Glucose, fructose and invert sugar are preferred in applications where phytotoxicity is a concern.

The substance also includes a wetting agent or a surfactant to stabilize the substance comprising the discontinuous phase of the rubber crumb carrier in the continuous aqueous phase of water. The wetting agent or surfactant may be present in an amount of 0.1-2.0% by weight of the overall substance.

The wetting agent and surfactant may be amphoteric, cationic, ionic, or nonionic. Further the wetting agent and surfactant may include alkyl polysaccharides, ether sulphates, ether phosphates, sulphosuccinates, ether carboxylates, naphthalene sulphonic acid salts, naphthalene sulphonate formaldehyde condensates, tristyrylphenol ethoxylates, castor oil ethoxylates, phosphate esters and condensates, aromatic hydrocarbon sulphonic acids and their salts and condensates, oleo-derived nonionic surfactants including sorbitan esters and polysorbates, alkyl polysaccharides, ethoxylates of natural alcohols and polyglycol fatty acid esters, fatty alcohol sulphates and fatty alcohol ether sulphates, mono-alkyl sulphosuccinates, alkyl ether carboxylates, sodium lauryl sulphate, alkyl ampho (di) acetates, alkyl dimethylamines, amine oxides, alkyl betaines, alkyl amideobetaines, fatty acid alkanolamides, alkylphenol ethoxylates, fatty alcohol ethoxylates, fatty amine ethoxylates, ethylene oxide-propylene oxide copolymers, ethylene glycol esters, fatty amine ethoxylates, fatty acid alkanolamides, fatty alcohol ethoxylates, lauric acid alkanolamides, nonylphenol ethoxylates, octylphenol ethoxylates, polyglycol esters of castor oil, dodecylphenol ethoxylates, dinonylphenol ethoxylates, sodium dioctyl sulphosuccinates, polyglycol esters of stearic acid, octylphenol ethoxylates and alcohol ethoxylates.

The rubber crumb carrier and the semiochemical received within the rubber crumb carrier when considered together may comprise 0.02 to 50% of the overall weight of the insect control substance including the body of water.

In this example embodiment the substance is formulated as an “attract and kill” formulation which includes an insecticide to kill the insect when it eats the rubber crumb carrier and a feeding stimulant to stimulate an insect to eat the rubber crumb carrier. The insecticide is capable of being mixed into the body of water forming the aqueous medium and includes one or more of the following: carbaryl, methyl, acephate, thiodicarb, cyfluthrin, malathion, chlorpyrifos ethyl, chlorpyrifos methyl, parathion methyl, parathion ethyl, malathion, emamectin benzoate, abamectin, spinosad, endosulfan, and Phloxine B. The insect feeding stimulant may include a sugar based compound that is suitable for being received within an aqueous medium. In particular the insect feeding stimulant may include liquid yeast autolysate, cucurbitacin compounds, sugars such as glucose, sucrose and fructose, cottonseed meal, oilseed meal and farinaceous meal.

### Method of Manufacture of the Insect Control Substance Described Above

The insect control substances can be manufactured as follows. The first stage involves forming the rubber crumb carrier. The second stage involves forming the body of water that is the continuous aqueous medium. The third stage involves dispersing the rubber crumb carrier within the aqueous medium to form an substance.

In the first stage a semiochemical is mixed with a volatility suppressant such as alpha tocopherol acetate or vitamin E acetate until the volatility suppressant is dissolved in the semiochemical to form a semiochemical mix. The volatility suppressant is mixed in the proportion of about 1 part volatility suppressant to 10 parts semiochemical. An anti-oxidant such as BHT, BHA or Vitamin E acetate is also mixed into the semiochemical mix together with the volatility suppressing agent and the semiochemical. As with the volatility suppressing agent the anti-oxidising agent is dissolved within the semiochemical. Typically the anti-oxidising agent the anti-oxidant may be added in an amount of 1 part anti-oxidant to 5 parts semiochemical. It will be appreciated that vitamin E acetate functions as both a volatility suppressing agent and an anti-oxidant and therefore if this component is included it will exert both a volatility suppressing and anti-oxidant effect. As with the volatility suppressing agent, the anti-oxidising agent is dissolved within the semiochemical. Typically the anti-oxidising agent the anti-oxidant may be added in an amount of 1 part anti-oxidant to 5 parts semiochemical.

The semiochemical mix is then mixed together with an amount of rubber particles at room temperature for 10-60 minutes and left to stand for 30-120 minutes. A ratio of 1 part semiochemical to 1 to 2 parts rubber crumb by weight is used. The components are mixed in a ribbon blender or a drum mixer such as that used for mixing cement. The resultant rubber crumb carrier is in the form of a flowable powder that is dry or slightly oily.

In the second stage of the manufacturing process the body of water forming the aqueous medium is prepared. To do this a thickener is added to the body of water and mixed therein. A colouring agent that is a mineral pigment is also mixed into the aqueous medium. A wetting agent and emulsifier, such as an alkyl polysaccharide and ether sulphate is also mixed into the aqueous medium.

An insecticide and a hydrophilic feeding stimulant are mixed into the aqueous medium and dissolved therein. Further any hydrophilic additives such as an anti-microbial agent and buffer can also be mixed into the aqueous medium at this time. The components above are mixed into the aqueous medium using a high speed blender.

In the third stage of manufacture the rubber crumb carrier is mixed into the aqueous medium with high speed agitation until it is evenly dispersed therein.

It will be understood that the concentration of the semiochemical in the rubber crumb carrier, the feeding stimulants and thickeners can be varied according to desired requirements for a given application. The end product is capable of being dispensed from a tube or a container such as a tank and can have a viscosity that ranges from a thick paste that is formable but not flowable and can be dispensed from a tube to a liquid that is flowable and is suitable for being dispensed from a container such as a tank.

### Application of the Insect Control Substance to the Control of Flying Insect Pests

In use the embodiment of the invention described above can be used to control flying insects in a field of broadacre crops with a view to minimizing the detrimental impact of the insects on the crop.

The substance which is in the form of an substance is mixed together with a suitable insecticide and insect feeding stimulant for the target flying insect to make it ready for use. The substance is placed in a tank from which it can be dispensed. Conveniently the tank is mounted on a wheeled vehicle such as a tractor or another farm vehicle that can be displaced along a path in the field to be treated.

The substance is dispensed from the container onto the ground surface as a thick liquid as the wheeled vehicle is displaced along the path. The substance forms a line on the ground behind the wheeled vehicle and adheres to the ground to some extent. Once the substance is applied to the surface the water is separated from the rubber crumb carrier, e.g. by evaporation, exposing the particles of rubber to the surrounding air. Non-volatile solutes in the aqueous medium remain on the surface of the rubber crumb carrier. After removal of the water the rubber crumb carrier forms a solid application body having a thickness of 5-10 mm on the application surface.

The hydrophobic semiochemical is able to slowly evaporate from the exposed rubber particles into the atmosphere. The released semiochemical within the rubber particles in the surrounding air can be detected by flying insects and attracts them to the rubber crumb carrier. The insects are encouraged to feed on the carrier by the feeding stimulant and when they ingest the insecticide they die.

The rubber crumb carrier slowly releases the semiochemical an in effective quantity over a prolonged period as shown in Examples 4 to 6. The application body adheres to plants and is shower or rain proof as shown in Examples 4 and 5.

In other embodiments the substance can be applied directly to a surface of the crop plant. For example the substance can be applied to the leaves of the plant. In another form the substance can be applied to support stakes for supporting the plant, for example support stakes that are used to support tomato plants.

While not wanting to be bound by this statement the Applicant believes that the rate of release of the semiochemical from the rubber crumb carrier is influenced inter alia by the following factors:
the size of the rubber particles;
the surface area of the application body that is exposed to air;
the concentration of sugar in the aqueous medium;
the molecular weight and vapour pressure of the semiochemicals; and
the presence of volatility suppressants in the formulation.

In a variation of the embodiment described above, a sugar based feeding stimulant is used in an “attract and kill” formulation having a “fast knockdown insecticide” either alone or in combination with a slow acting insecticide. This may minimize the undesired destruction of bees that are attracted to the toxic bait. The “fast knockdown insecticide” will kill rapidly any scout bees that may locate the bait and will therefore prevent the scout bees communicating the whereabouts of the toxic bait to the other bees in the hive.

In conclusion, the inclusion of a rubber crumb carrier in a semiochemical formulation prolongs release of the semiochemicals from the formulation. Semiochemical release is prolonged if a larger amount of rubber crumb carrier is used and if larger particles of the carrier are used in the formulation. Increasing the amount of the anti-oxidant alpha tocopherol further slows down the release of the semiochemicals.

An advantage of the insect control substance described above in the detailed description is that it is capable of using a hydrophobic semiochemical yet it is suitable for use with aqueous based insecticides and feeding stimulants. As discussed water based insecticide formulations have advantages over non aqueous or solvent based insecticides. Firstly hydrophilic feeding stimulants such as sugars and proteins are easy to incorporate into the formulation.

Secondly commercial manufacture of the water based formulations is less expensive than that of solvent based formulations and therefore the products themselves are less costly. Further the manufacture of water based formulations is simpler and there is less regulation and cost associated with the handling and disposal of the water than with solvents. Thirdly water based formulations can be applied directly to leaves of foliage without causing phytotoxic effects. In this invention the hydrophobic semiochemical passes directly from the inside of the rubber particles into the surrounding air and does not make contact with the crop. Further the consistency of water based formulations can easily be adjusted by thinning with water.

Further it should also be borne in mind that the formulation is also suitable for incorporation with water insoluble feeding stimulants and toxicants as part of an “attract and kill” formulation and is therefore quite versatile.

A further advantage of the insect control substance described above in the detailed description of the preferred embodiment is that it is very specifically applied and therefore uses lower levels of active semiochemical and agent than insect control substances that rely on complete coverage of an area of crops. Further it uses a decreased amount of formulation per unit area because the semiochemical attracts flying insects to the carrier instead of relying on complete coverage of the area or plants. Further the carrier provides for a substantially constant rate and continuous release of the semiochemical over an extended period.

Consequently with this insect control substance there is decreased environmental pollution due to specific application of the formulation and biodegradability of the formulation. Further the substance is safer for agricultural workers to use than insecticide sprays. Yet further it uses an inexpensive recycled rubber crumb carrier which can be obtained from vehicle tyres and it is relatively non-toxic and biodegradable. It has a low risk of plant phytotoxicity and can be manufactured at reasonable cost.

Further the rubber crumb particles when combined with semiochemicals remain in the form of a flowable powder which is suitable for handling and further processing. Therefore, the formulation can be mixed at room temperature, thereby avoiding high heating and subsequent cooling costs and expensive residence times in the mixing equipment.

A further advantage of the insect control substance described above is that it can be very efficacious at controlling flying insects with strong wings and strong flying abilities such as moths. Applicant has found that mating disruption strategies may produce sub-optimal results for some moths because the strong flying action of the moth is able to overcome the false signal given by the pheromone that is released and eventually find the female. Although it takes longer for the mating male to find the female and it consumes more energy the male moth is still able to find the female.

Thus mating disruption is not effective. By contrast the substance described above, attracts the moth and then kills it as soon as it lands on the crop and thereby is equally effective at treating insects with strong flying actions.

Yet further the insect control substance described above is very effective because it kills the flying insects when they land on the crop and before they lay their eggs. It therefore interrupts the life cycle before the moth eggs are laid and larvae in the form of worms can hatch from the eggs. It is these worms that cause damage to crops such as apples, peaches and pears.

### EXAMPLES

Several examples have been carried out by the Applicant to demonstrate the efficacy of this invention in controlling certain flying insect pests in the field.

### Example 1

An insect control substance having the composition set out below was used to control adult Noctuidae, such as Helicoverpa in a field of broadacre crops.

| Ingredients | Percentage w/w |
|---|---|
| Sucrose | 40.0% |
| Golden syrup (invert sucrose) | 10.0% |
| Water | 43.1% |
| Xanthan | 1.00% |
| Titanium oxide | 1.00% |
| Kraft apple green food dye | 0.05% |
| Hydrophobic volatile moth attractants | 2.00% |
| BHT | 0.40% |
| Vitamin E Acetate | 0.40% |
| Rubber crumb 30 mesh | 2.00% |
| Total | 100% |

The insect control substance above was applied in an amount corresponding to 2-4 kg/hectare of crop.

The vitamin E acetate functions as both a volatility suppressing agent and an anti-oxidant. In another example the volatility suppressing agent that is alpha tocopherol was substituted for the volatility suppressing agent Vitamin E acetate. The performance of this example in controlling adult Noctuidae such as Helicoverpa in a field of broadacre crops was comparable to that of example 1.

### Example 2

An insect control substance having the composition set out below was used to control Corn rootworm beetles. An insecticide was added to the insect control substance prior to use.

| Ingredients | Percentage w/w |
|---|---|
| Woodflour 50 mesh | 20.0% |
| Cucurbitacin E Glycoside (10% in ethanol) | 0.4% |
| Water | 72.7% |
| Xanthan | 2.00% |
| Titanium oxide | 1.00% |
| Potassium sorbate | 0.10% |
| Hydrophobic volatile beetle attractants | 1.00% |
| BHT | 0.40% |
| Vitamin E Acetate | 0.40% |
| Rubber crumb 30 mesh | 2.00% |
| Total | 100% |

The insect control substance above was applied in an amount corresponding to 1 kg/hectare of a corn crop.

The vitamin E acetate functions as both a volatility suppressing agent and an anti-oxidant. In another example a volatility suppressing agent that is alpha tocopherol was substituted for the volatility suppressing agent Vitamin E acetate.

### Example 3

An insect control substance having the composition set out below including a kairomone as the semiochemical was used to attract aphid predators.

| Ingredients | Percentage w/w |
|---|---|
| Water | 48.0% |
| Xanthan | 2.0% |
| Potassium sorbate | 2.0% |
| Ferric Oxide | 2.0% |
| Hydrophobic aphid predator kairomone | 15.0% |
| (50% Z, 3 hexenyl acetate and 50% methyl salicylate) | |
| Hydrophobic aphid alarm pheromone-E beta farnesene | 5.0% |
| BHT | 1.0% |
| Vitamin E Acetate | 5.0% |
| Rubber crumb 30 mesh | 20.00% |
| Total | 100% |

The vitamin E acetate functions as both a volatility suppressing agent and an anti-oxidant

The Formulation was applied to rose bushes.

### Example 4

In this example the field life and rain resistance of two insect control substances was compared and contrasted. One substance (Formulation 1) was in accordance with the invention of this application and the other was not. The substances were used to control of adult female Helicoverpa spp. moths in a cotton crop.

### Ingredients of Formulation 1

Formulation 1 includes an attractant in a rubber crumb carrier suspended in aqueous sugar solution and has the following composition.

Percentage w/w

| | |
|---|---|
| Sucrose | 40.00% |
| Invert sucrose | 10.00% |
| Water | 43.65% |
| Xanthan | 1.00% |
| Titanium dioxide | 0.50% |
| Kraft apple green food dye | 0.05% |
| Semiochemicals | 2.30% |
| Anti-oxidants | 0.50% |
| Rubber crumb 30 mesh | 2.00% |
| Total | 100.00% |

The semiochemical in this Formulation 1 comprised the following:

| | |
|---|---|
| Phenylacetaldehyde 50% in dpg | 0.60% |
| Methyl 2methoxybenzoate | 0.30% |
| Limonene | 0.20% |
| Methyl salicylate | 0.20% |
| Z, 3 Hexenyl acetate | 0.20% |
| 4 methoxybenzyl alcohol | 0.20% |
| beta caryophyllene | 0.20% |
| Anethole | 0.20% |
| linalool | 0.20% |

### Ingredients of Formulation 2

Formulation 2 is an insect control substance containing similar active ingredients to Formulation 1. However, the active ingredients were added directly to the aqueous medium without the use of the rubber crumb carrier.

### Method of Comparative Tests

Both Formulation 1 and Formulation 2 were applied to the cotton plants at the same time. Formulation 1 and Formulation 2 was applied to two fields of cotton.

Formulation 1 in combination with 20 ml of an insecticide Larvin 9 was applied at an amount of 1000 ml per 100 metres to 4×50 metre strips on rows located between those treated with Formulation 2. Formulation 2 in combination with Marlin toxicant at 30 ml per litre of Formulation was applied to whole rows of cotton at an amount of 750 ml per 100 metres to rows spaced 72 m apart.

Field 1 was planted with Bollgard II cotton. Two rows, 72 metres apart, were treated with 750 ml per 100 metres of row of Formulation 2 in combination with Marlin toxicant at 30 ml per litre of formulation. Two rows, 36 metres each side of the Formulation 2 treated rows, were treated with Formulation 1 in combination with 20 ml of Larvin (g) per litre.

Field 2 was planted with conventional cotton and treated with Formulation 2 with Marlin toxicant at 30 ml per litre of formulation at an amount of 750 ml per 100 metres to rows spaced 72 m apart. Formulation 1, in combination with 20 ml of Larvin (g) per litre, was applied to rows of cotton 36 metres on either side of the rows treated with Formulation 2.

Counts of dead moths were made along two rows on either side of the treated rows. Counts were carried out 1, 3, 6 and 8 days after the initial application of the formulations.

### Results

Formulation 1 remained effective without a detectable decline in activity for the eight day period of this trial. Deposits of Formulation 1 remained largely intact and effective after two falls of rain, showing that the formulation resists being washed away by the rain. Formulation 2 was almost as active as Formulation 1 on the first night of application but its efficacy in killing moths declined after the second day. Formulation 2 appeared to have no resistance to rain and appeared to be washed away by rain showers.

The number of dead moths per 50 metres on 2 rows of crops were counted on each side of the treated row.

| | | |
|---|---|---|
| Field 1 | Field 2 | No. of moths |

| | | | | | |
|---|---|---|---|---|---|
| Replicate | 1 | 2 | 3 | 4 | Total |

Day 1

| | | | | | |
|---|---|---|---|---|---|
| Formulation 2 | 1 | 4 | 1 | 0 | 6 |
| Formulation 1 | 1 | 6 | 2 | 1 | 10 |

Day 3

| | | | | | |
|---|---|---|---|---|---|
| Formulation 2 | 2 | 1 | — | — | 3 |
| Formulation 1 | 3 | 11 | — | — | 14 |

Day 6

| | | | | | |
|---|---|---|---|---|---|
| Formulation 2 | 1 | 0 | — | — | 1 |
| Formulation 1 | 7 | 8* | — | — | 15 |

Day 8

| | | | | | |
|---|---|---|---|---|---|
| Formulation 1 | 13 | 20* | — | — | 15 |

*includes one armyworm moth that was probably Spodoptera spp.

The gaps in the data on Field 2 were due to irrigation applied to Field 2 over the course of the experiment.

FIG. 1 is a graph showing the number of moths killed by Formulations 1 and 2 over the trial period. The values shown in FIG. 1 are a mean an experiment that was repeated twice. Formulation 1 remained active on Day 8 even though 10 mm of rain fell on the fields the previous night. The rain resulted in a complete wash-off of Formulation 2 and only a partial loss and repositioning of Formulation 1.

### Discussion

Based on the observations of the performance of the two formulations, Formulation 1 clearly demonstrated superior efficacy to Formulation 2. Formulation 1 and Formulation 2 were equally effective in killing moths on Day 1. After Day 1 the effectiveness of Formulation 2 reduced significantly. The difference in performance between the two formulations is most likely due to the fact that in Formulation 1 the semiochemical was received within a rubber crumb carrier.

Formulation 1 remained effective for at least eight days without any significant reduction in performance. On the sixth day the deposits of Formulation 1 were still visible and noticeably fragrant. By comparison Formulation 2 appeared to lose most of its activity and fragrance by the third day. Further Formulation 1 remained active after 20 mm of rain. From this it is therefore reasonable to conclude that the product resists wash off due to rain.

### Example 5

In this example the field life and rain resistance of a substance in accordance with the invention for control of adult female Helicoverpa spp. moths in mung beans was compared and contrasted with two other substances that did not incorporate the key features and principles of the invention claimed in this application.

The substance in accordance with the invention (Formulation 1) comprised a rubber based controlled release system or carrier for the attractant volatiles suitable for attracting adult male and female Helicoverpa spp. moths. One substance not in accordance with the invention (Formulation 2) comprised an attractant volatile without a rubber crumb carrier suitable for attracting adult male and female Helicoverpa spp. moths. The other substance not in accordance with the invention was a control substance containing a feeding stimulant in a sugar based aqueous medium but with no semiochemical attractant.

The compositions of Formulations 1 and 2 are set out below.

### Ingredients of Formulation 1

| Component | Percentage w/w |
|---|---|
| Sucrose | 40.00% |
| Invert sucrose | 10.00% |
| Water | 43.65% |
| Xanthan | 1.00% |
| Titanium dioxide | 0.50% |
| Kraft apple green food dye | 0.05% |
| Semiochemicals | 2.30% |
| Anti-oxidants | 0.50% |
| Rubber crumb 30 mesh | 2.00% |
| Total | 100.00% |

### Formulation 2

| Component | Percentage Weight |
|---|---|
| Phenylacetaldehyde 50% in dpg | 0.60% |
| Methyl 2methoxybenzoate | 0.30% |
| Limonene | 0.20% |
| Methyl salicylate | 0.20% |
| Z, 3 Hexenyl acetate | 0.20% |
| 4 methoxybenzyl alcohol | 0.20% |
| beta caryophyllene | 0.20% |
| Anethole | 0.20% |
| linalool | 0.20% |
| Total | 100% |

Formulation 1 (in accordance with the invention) and formulation 2 (without the rubber crumb carrier) and the control substance containing ‘feeding stimulant only’ were each applied to seven 50 metre strips in a flowering mung bean crop. The layout is indicated in FIG. 2 where reference numerals 1 and 2 indicate fields and numeral 3 denotes a dam. Numeral 4 denotes a road and numeral 5 denotes a row of crops.

In this example Formulation 1 and the control were applied at an amount of 1000 ml per 100 metres using Larvin 375X toxicant at an amount of 20 ml per litre of formulation. Formulation 2 was applied at an amount of 750 ml per 100 metres of crops using Marline toxicant (30 ml per litre of formulation). Formulations 1, 2 and the control formulation were randomly applied to the rows of crops. The effectiveness of each formulation was assessed by the number of moths killed on days 1, 2, 4, 6 and 8 after the initial application of the formulations. Dead moths which were identified by genus only were collected in the two adjoining rows of crops on either side of the treated row.

### Results

On Days 1 and 2 both Formulations 1 and 2 were equally effective and killed significantly more moths than the control formulation. After Day 2 the formulation 1 killed progressively more moths on each day than Formulation 2. The results are shown in FIG. 3 which indicates the number of moths killed by the respective formulations over an 8 day period. The values shown in the graph represent the mean result obtained from an experiment that was carried out three times.

FIG. 3 shows that the Formulation 1 in accordance with the invention was superior to both Formulation 2 and the feeding stimulant control throughout the 8 day trial.

### Discussion

On day 8, at the end of the trial, the crop was senescing and therefore no longer attractive for moths. At this point in time Formulation 1 remained effective but the number of moths in the locality was declining. Evidence of the decline is supported by the declining number of moths killed by the ‘feeding stimulant only’ control over the 8 days. Therefore, it can be concluded that the field life of Formulation 1 is at least 8 days.

### Example 6

A headspace analysis was conducted out to measure the amount of semiochemicals released from a range of insect control substances in accordance with the invention over an extended period. This was compared and contrasted with an experimental control which did not include the rubber crumb carrier.

The release rates of seven biologically active semiochemicals in a number of rubber crumb carriers were examined by headspace analysis using gas chromatography and mass spectrometry. A control formulation which did not comprise a rubber crumb carrier was also examined in the same way. The release of the semiochemicals from the ‘no carrier’ control was high and decreased rapidly over the first three or four days of the experiment. The incorporation of the semiochemicals into a 30 mesh rubber crumb carrier at an amount of 1 gram of semiochemicals per gram of rubber crumb resulted in a marked slowing of the release from the formulation when compared with the ‘no carrier’ control. Incorporation of the semiochemicals into a finer grade of rubber crumb (80 mesh) gave a steady but higher release rate. An increase in the Vitamin E acetate (anti-oxidant) content from 0.1% to 0.4% slowed the release rate of the semiochemicals. Further increasing the 30 mesh rubber content from 2% to 4% while the semiochemical remained constant also slowed the release of the semiochemicals.

### Experimental Formulations

Five experimental formulations were prepared by mixing semiochemicals (Table 1) with various rubber crumb carriers (Table 3) into an aqueous sugar solution base (Table 2).

TABLE 1
The percentage by weight of the components in the mixture
of semiochemicals and stabilisers * is set out below.

| Semiochemicals and | Percentage by |
|---|---|
| stabilisers | weight |
| Methyl 2-methoxybenzoate | 15 |
| Limonene | 10 |
| Methyl salicylate | 10 |
| Z, 3 Hexenyl acetate | 10 |
| beta caryophyllene | 10 |
| Anethole | 10 |
| linalool | 10 |
| BHT (anti-oxidant) | 20 |
| Vitamin E Acetate | 5 |

* common to all formulations

TABLE 2
The percentage by weight of the components in
the aqueous sugar solution is set out below.

| | |
|---|---|
| Cane sugar | 40.0 |
| Invert sugar | 10.0 |
| Water | 48.6 |
| Xanthan (thickener) | 0.8 |
| Titanium dioxide | 0.5 |
| Kraft apple green | 0.1 |

* common to all formulations

The mixture of semiochemicals and stabilisers (Table 1) was incorporated into the rubber carrier and allowed to stand for one hour. This mixture was then incorporated into the aqueous sugar solution (Table 2). No carrier was used with experimental Formulation 5. The semiochemicals were directly incorporated into the base. The experimental formulations are summarized in Table 3.

TABLE 3
The percentage by weight of the components in the experimental
formulations is set out in the table below.

| | | | 30 mesh | 80 mesh | Additional |
|---|---|---|---|---|---|
| Formulation | | Semiochem | rubber | rubber | Vitamin E |
| number | Base | mixture | carrier | carrier | Acetate |
| 1 | 96.00 | 2.00 | 2.00 | 0.00 | 0.00 |
| 2 | 96.00 | 2.00 | 0.00 | 2.00 | 0.00 |
| 3 | 94.00 | 2.00 | 4.00 | 0.00 | 0.00 |
| 4 | 95.85 | 2.00 | 2.00 | 0.00 | 0.15 |
| 5 | 98.00 | 2.00 | 0.00 | 0.00 | 0.00 |

### Headspace Methodology

A plurality of three hundred milligram samples of the above experimental formulations were placed in 8 mm diameter plastic bottle lids. The lids were exposed in a simulated outdoor situation with free air movement. The samples were not directly exposed to rain but were subject to fluctuations in humidity. The lids containing the experimental formulations were tested on days 1, 2, 4 and 7 after exposure. The lids were placed in the bottom of 20 ml glass sample vials and allowed to equilibrate for 20 minutes. The semiochemical ingredients in the headspace sample were sampled using Solid Phase Micro Extraction and measured and analysed with a Varian gas chromatograph/mass spectrometer.

### Results

The results are presented in FIGS. 4 to 8 showing graphs of the release of semiochemicals from formulations 1 to 5 using the headspace analysis. As shown in FIG. 4, the release of Formulation 1 comprising 2% of 30 mesh rubber particles in the rubber crumb carrier and 0.1% of anti-oxidant in the form of Vitamin E acetate slowly decreased over the first 3 days and then increased considerably on Day 4. The release continued to increase until the end of the trial (7 days).

As shown in FIG. 5, the release of Formulation 2 comprising 2% of 80 mesh rubber particles in the rubber crumb carrier and 0.1% of anti-oxidant in the form of Vitamin E acetate slowly fluctuated over the 4 days but the average semiochemical release did not substantially change over that time. The release continued to increase until the end of the trial (7 days).

As shown in FIG. 6, the release of Formulation 3 comprising 4% of 30 mesh rubber particles in the rubber crumb carrier and 0.1% of anti-oxidant in the form of Vitamin E acetate was stable over the first 3 days and accelerated on Day 4. The release continued to increase until the end of the trial (7 days).

As shown in FIG. 7, the release of Formulation 4 comprising 2% of 30 mesh rubber particles in the rubber crumb carrier and 0.4% of anti-oxidant in the form of Vitamin E acetate decreased by Day 2 and accelerated on Day 3. The release continued to increase until the end of the trial (7 days).

As shown in FIG. 8, the release of Formulation 5, the control formulation comprising no rubber crumb carrier and no anti-oxidant in the form of Vitamin E acetate was very high on Day 1. However, the release decreased exponentially over the following days. By day 3 the levels of semiochemicals were barely detectable.

### Discussion

The results of the headspace analysis demonstrated clear and significant differences in release rates of semiochemical in the different formulations.

The results for control Formulation 5 (in which the semiochemical active ingredients were incorporated directly into the aqueous base) demonstrate emission of semiochemical from the formulation stops on Day 3 to Day 4. Therefore the usefulness of such a formulation is very limited after three or four days. The results of Formulations 1 to 4 (comprising a rubber crumb carrier) demonstrate the presence of the rubber crumb carrier significantly prolongs the release of semiochemical from the formulations.

Rainfall occurred between Days 3 and 4, resulting in cooler conditions and a decline in the semiochemical release rate observed on Day 4. However, the release rates in all the carrier containing formulations returned to normal day 7 and showed no signs of decreasing. The results indicate clearly that the formulations incorporating the rubber carrier continued to effectively release semiochemicals on Day 7.

Use of a fine 80 mesh rubber carrier (FIG. 5; Formulation 2), a higher amount of carrier in the formulation (FIG. 6; Formulation 3) or more Vitamin E Acetate (FIG. 7; Formulation 4) further improved the effectiveness of semiochemical release from the formulations.

Some examples of semio-chemicals that can be used in this invention include kairopmones. Examples of kairomones are provided in U.S. Pat. No. 6,074,634, in the name of Lopez et al., incorporated herein by reference. The mixture of kairomones described in U.S. Pat. No. 6,074,634 or similar mixtures of plant semiochemicals or volatiles are effective in attracting Helicoverpa and related noctuid moth pests. When used in combination with a feeding stimulant such as sucrose and a suitable toxicant, this product is useful for control of moths such as Helicoverpa spp. and Spodoptera spp., the larvae of which species are highly destructive pests of agriculture, lawns and turf.

Further some examples of noctuid attractants are provided in International Patent Application No. PCT/AU02/01765 in the name of Bioglobal Ltd, which is incorporated herein by reference. Examples of noctuid attractants include phenylacetaldehyde, methyl 2-methoxybenzoate, limonene, methyl salicylate, anisyl alcohol, beta caryophyllene, anethole and linalool.

Some other examples of the invention of this application showing its application to the control of certain insects on certain crops are discussed below.

For the control of corn rootworm and cucumber beetles (Diabrotica and Acalymma spp.), 1,2,4-trimethoxybenzene, indole, cinnamaldehyde, 4-methoxycinnamaldehyde and cinnamyl alcohol may be used as semiochemicals (Metcalf and Metcalf, U.S. Pat. No. 6,613,317). The semiochemical/rubber crumb mix may also be mixed with cucurbitacin adsorbed onto the surface of a suitable hydrophilic carrier, such as woodflour or a cellulose powder. The mixture can then be incorporated into an aqueous medium together with a toxicant or insecticide. This formulation can be applied as a paste or as a thick liquid to tomatoes, cucumbers, corn or other susceptible garden plants and agricultural.

For the control of fruit flies a formulation comprising a kairomone such as cue-lure, methyl eugenol, raspberry ketone, terpinyl acetate, ginger root oil and similar known attractants may be effective. The formulation may also include a feeding stimulant, such as yeast autolysate and a suitable toxicant. The formulation can be applied as a paste or as a thick liquid to fruit trees or bushes to prevent infestation of fruit. For the control of aphids, aphid alarm pheromones such as E, beta farnesene may be incorporated into rubber crumb. No feeding stimulant or toxicant would be required in the formulation. Volatile repellents of aphids or kairomonal attractants for aphid predators may be added to the formulation to complement the aphid alarm pheromone.

Non-aqueous based “attract and kill” formulations such as Sirene are known. Sirene is formulated as a thick, sticky, black substance that is tar-like in appearance and contains 0.16% codlemone and 6% permethrin, a fast-acting synthetic pyrethroid insecticide. Sirene uses the “attract and kill” concept to reduce adult male codling moth numbers which results in a decrease in mating between male and female moths and consequently decreased offspring. The paste is applied topically to branches and scaffold limbs and is unsuitable for application by spaying because it is not water dispersible. It is also unsuitable for application to foliage because of phytotoxic properties. Water based bait formulations have some definite advantages over non-aqueous baits like Sirene (g). Commercial manufacture of the water based bait formulations is usually less costly and complicated and hydrophilic feeding stimulants such as sugars or proteinaceous feeding stimulants are relatively easy to incorporate into the formulation. Suitably formulated water based baits can be applied direct to foliage efficiently, without phytotoxic effects, by spraying using mechanical means. The consistency of the formulation can be adjusted by thinning with water.

Water based bait adjuvants for insecticides and insect pathogens are used to some degree in Australian cotton fields and other broad acre crops. Products include Mobait and Aminofeed which target larvae which cannot fly. For this reason, they are diluted and applied to the entire crop with a cover spray.

An example of a thick water based bait which targets adult insects is yeast autolysate and similar proteinaceous baits for fruit flies. Fruit flies are attracted to volatile semiochemicals released by the protein in the bait. However, one major disadvantage of a water based bait and formulation is that it is susceptible to being removed by rain and watering. Leafy vegetable crops, such as cabbage, lettuce, celery and sweet corn are predominantly watered by overhead irrigation resulting in wash off of the water-based bait/insecticide formulations. Therefore frequent spraying of the crops with the formulation is required which is a costly exercise. This invention is concerned with a method of pest control and in particular a semiochemical formulation comprising a carrier that allows sustained release of agricultural pest control agents.

Also another major disadvantage of a water based bait and formulation is it is not miscible or dispersible with hydrophobic volatile semiochemicals. Oils and waxes are also used as carriers for volatile hydrophobic compounds such as pheromones. U.S. Pat. No. 6,001,346, in the name of Delwiche et al., describes a sprayable or solid wax carrier comprising insect pheromones for the disruption of insect mating. The wax formulation of this patent comprises emulsifiers and therefore is phytotoxic to foliage. Consequently, the formulation is only topically applied to the bark of trees. Similarly, some humectants such as glycerol, which are used for keeping sugar based feeding stimulants moist, are phytotoxic when applied thickly to foliage.

U.S. Pat. No. 5,837,273, in the name of Shasha et al., describes compositions and a method of encapsulating biologically active agents in starch-based adherent molecules for the control of insects and other pests having chewing mouth parts and amylase digestive enzymes. The granules are applied to the surface of plant foliage and adhere to the surface of foliage even in rainy and windy conditions. The disadvantage of this method is that the adherent granules are complicated in structure requiring the incorporation of pregelatinised starch and a water dispersant, and thus are costly to manufacture. The granules are not suitable for incorporation of hydrophobic volatile semiochemicals because they are hydrophilic in nature.

It will of course be realized that the above has been given only by way of illustrative example of the invention and that all such modifications and variations thereto, as would be apparent to persons skilled in the art, are deemed to fall within the broad scope and ambit of the invention as is herein set forth.

1. An insect control substance for controlling certain flying insect pests in proximity thereto, including:
a rubber crumb carrier comprising a plurality of rubber particles and a volatile hydrophobic semiochemical for attracting certain flying insect pests absorbed within the rubber particles forming a discontinuous phase of the substance;
a body of water forming a continuous phase of the substance within which the discontinuous phase is suspended,
wherein when the insect control substance is applied to an application surface the discontinuous phase formed by the rubber crumb carrier is exposed to the surrounding air and the semiochemical within the rubber particles evaporates into air around the application surface and attracts the flying insect pests to the rubber crumb carrier whereby to facilitate control of the flying insect pests.

2. An insect control substance according to claim 1, wherein the rubber crumb carrier includes a volatility suppressing agent mixed together with the semiochemical that is absorbed within the rubber particles for retarding the rate at which the semiochemical evaporates from the rubber crumb thereby extending the length of time over which semiochemical is released into the surrounding air.

3. An insect control substance according to claim 1, wherein the body of water forming the continuous aqueous phase of the substance includes a thickener for increasing the viscosity of the substance.

4. An insect control substance according to claim 1, wherein the semiochemical is substantially evenly distributed throughout each rubber particle and wherein each rubber particle is substantially saturated with semiochemical.

5. An insect control substance for controlling certain flying insect pests in proximity thereto, including:
a plurality of rubber particles forming a rubber crumb carrier;
a volatile hydrophobic semiochemical absorbed within the rubber particles for attracting certain flying insect pests,
wherein on application of the insect control substance to an application surface, the rubber articles are exposed to surrounding air and the semiochemical within the rubber particles evaporates from the rubber particles, whereby to attract the flying insect pests to the substance and thereby facilitate control of the flying insect pests.

6. An insect control substance according to claim 5, wherein substantially all the rubber particles are sized to pass through a mesh opening of not more than 2.00 mm.

7. An insect control substance according to claim 5, including a body of water within which the rubber crumb carrier is received which resists evaporation of the semiochemical from the rubber particles until the water is removed from the rubber crumb carrier thereby permitting the semiochemical to evaporate from the rubber particles into the surrounding air.

8. An insect control substance according to claim 5, further including a volatility suppressing agent mixed together with the semiochemical for retarding the rate at which the semiochemical vapourises from the rubber crumb carrier into the surrounding air,

9. An insect control substance according to claim 5, including a thickener mixed together with the rubber crumb carrier for increasing the viscosity of the body of water and the rubber crumb carrier received therein, and increasing the thickness of a layer of rubber crumb carrier that is dispensed onto the application surface.

10. An insect control substance according to claim 5, including an insect harming agent mixed with the rubber crumb carrier for harming insects that are attracted by semiochemical passing from the rubber particles into the surrounding air, wherein the insect harming agent is an insecticide that kills at least some of the flying insects that are attracted to the substance.

11. An insect control substance according to claim 10, further including a feeding stimulant mixed with the rubber crumb carrier for stimulating a flying insect to consume the rubber crumb carrier and thereby the insecticide.

12. A method of controlling certain flying insects in proximity to a field of agricultural crops whereby to reduce crop damage caused by the flying insects, including:
applying an insect control substance to a treatment surface within the field, the insect control substance including a plurality of rubber particles containing a volatile hydrophobic semiochemical for attracting certain flying insect pests, the semiochemical being absorbed within the rubber particles to form a rubber crumb carrier; and
exposing the rubber crumb carrier to air to allow the semiochemical in the rubber particles to evaporate from the rubber particles into surrounding air for attracting certain flying insect pests thereto to facilitate control of the flying insect pests.

13. A method of controlling certain flying insects according to claim 12, wherein the insect control substance is in a flowable form, and applying the insect control substance may include causing the substance to flow out of a container onto the application surface, and wherein the container is displaced while the substance flows out of the container whereby to deposit the substance in a line along the application surface.

14. A method of controlling certain flying insects according to claim 13, wherein exposing the rubber crumb carrier to surrounding air includes removing the water that surrounds the rubber crumb carrier whereby to permit semiochemical to pass from the rubber particles into the surrounding air.

15. A method of controlling certain flying insects according to claim 13 including applying the insect control substance to a treatment surface that is a ground surface in a straight line that extends between two linear rows of crops in a field of crops.

16. A method of making an insect control substance that can be applied to an application surface for controlling insects, the method including:
mixing a plurality of rubber particles with a liquid semiochemical for a period of time that is sufficient to enable the rubber particles to absorb the semiochemical to form a rubber crumb carrier; and
closing the rubber crumb carrier off from exposure to the atmosphere whereby to resist evaporation of absorbed semiochemical from the rubber particles until the insect control substance is to be used.

17. A method of making an insect control substance that can be applied to an application surface according to claim 16, including mixing a volatility suppressant together with the semiochemical so that the volatility suppressant is absorbed into the rubber particles together with the semiochemical.

18. A method of making an insect control substance that can be applied to an application surface according to claim 16, wherein closing the rubber crumb carrier off from exposure to the atmosphere includes receiving the rubber crumb carrier within a body of water so that the rubber particles are not exposed to air in the atmosphere.

19. A method of making an insect control substance that can be applied to an application surface according to claim 16, wherein the method includes mixing a thickener with the body of water prior to it being mixed with the rubber crumb carrier.

20. A method of making an insect control substance that can be applied to an application surface according to claim 19, wherein the method includes mixing one or more of a colouring agent, a humectant; and an anti-microbial agent with the body of water prior to it being mixed with the rubber crumb carrier.
